(19) United States
(12) Patent Application Publication
(10) Pub. No.: US 2026/0079309 A1
(43) Pub. Date: Mar. 19, 2026

(54) OPTICAL DEVICE AND METHOD OF MANUFACTURE

(71) Applicant: Taiwan Semiconductor Manufacturing Co., Ltd., Hsinchu (TW)

(72) Inventors: Chiahung Liu, Hsinchu (TW); Chia-Han Tsou, Hsinchu (TW); Yu-Siang Lin, Hsinchu (TW); Ming-Fa Chen, Taichung City (TW)

(21) Appl. No.: 18/884,803

(22) Filed: Sep. 13, 2024

(51) Int. Cl. G02B 6/42

(52) U.S. Cl. CPC G02B 6/4206

(57) ABSTRACT

Optical devices and methods of manufacture are presented in which a metasurface is utilized to assist optical signals as the optical signals transit between an external device such as an optical fiber and an edge coupler located within a first optical package. The metasurface includes meta-atoms which may be used to help lead the optical signals to the edge coupler.

### BACKGROUND

Electrical signaling and processing is one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) dies including optical devices and electronic dies including electronic devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-9 illustrate formation of a first optical package, in accordance with some embodiments.

FIGS. 10A-10C illustrate a metasurface placed on the first optical package, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be discussed with respect to certain embodiments in which a metasurface is utilized in order to assist optical signals in the transition from an optical fiber to an edge coupler within a photonic integrated circuit. The embodiments presented, however, are intended to be illustrative and is not intended to limit the ideas presented to the precise embodiments described. Rather, the ideas presented may be incorporated into a wide variety of embodiments, and all such embodiments may be included within the overall scope of the disclosure.

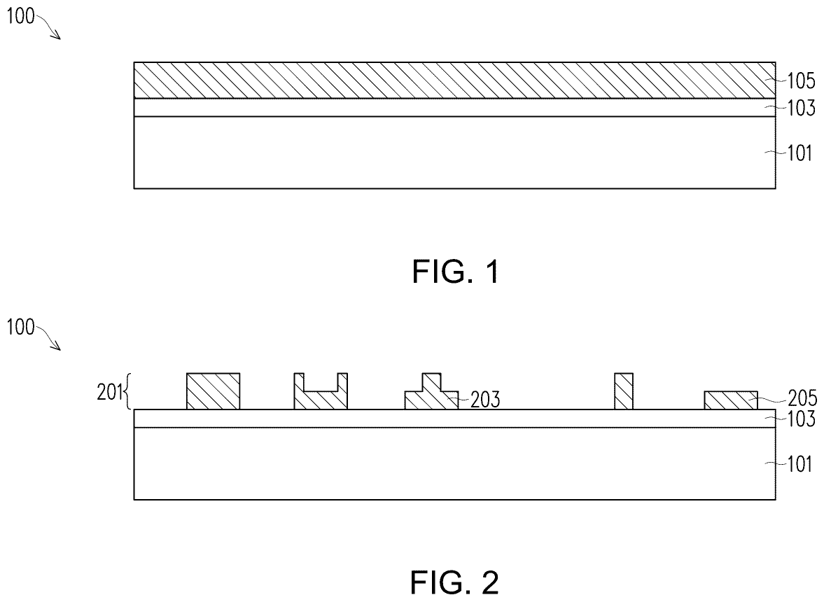

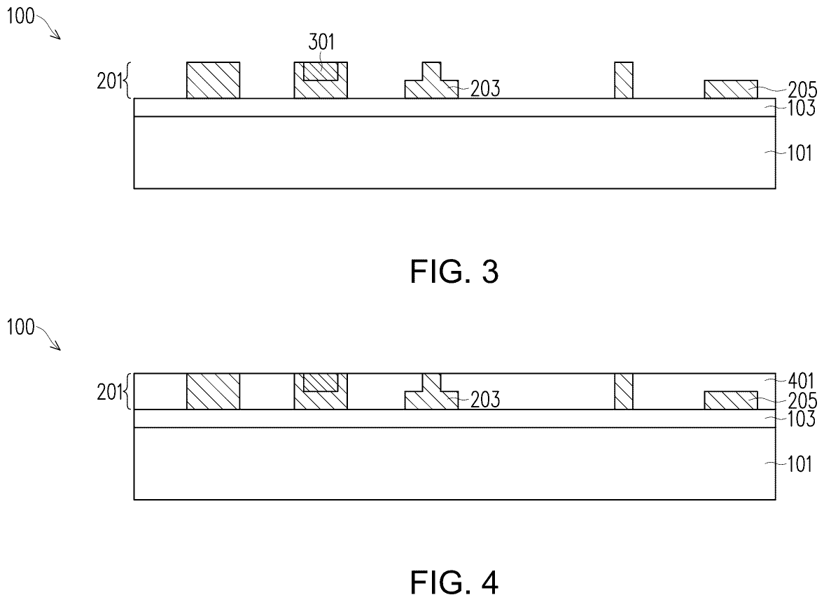

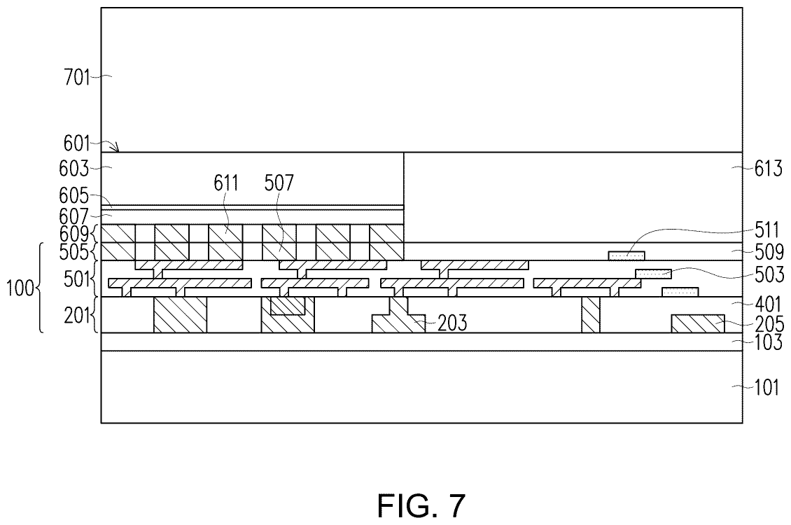

With reference now to FIG. 1, there is illustrated an initial structure of an optical interposer 100 (seen in FIG. 5), in accordance with some embodiments. In the particular embodiment illustrated in FIG. 1, the optical interposer 100 is a photonic integrated circuit (PIC) and comprises at this stage a first substrate 101, a first insulator layer 103, and a layer of material 105 for a first active layer 201 of first optical components 203 (not separately illustrated in FIG. 1 but illustrated and discussed further below with respect to FIG. 2). In an embodiment, at a beginning of the manufacturing process of the optical interposer 100, the first substrate 101, the first insulator layer 103, and the layer of material 105 for the first active layer 201 of first optical components 203 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 201 and can additionally, in some embodiments, serve as a portion of cladding material that surrounds the subsequently manufactured first optical components 203 (discussed further below). In an embodiment the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material 105 for the first active layer 201 is initially (prior to patterning) a conformal layer of material that will be used to begin manufacturing the first active layer 201 of the first optical components 203. In an embodiment the material 105 for the first active layer 201 may be a translucent material that can be used as a core material for the desired first optical components 203, such as a semiconductor material such as silicon, germanium, silicon germanium, combinations of these, or the like, while in other embodiments the material 105 for the first active layer 201 may be a dielectric material such as silicon nitride or the like, although in other embodiments the material 105 for the first active layer 201 may be III-V materials, lithium niobate materials, or polymers. In embodiments in which the material 105 of the first active layer 201 is deposited, the material 105 for the first active layer 201 may be deposited using a method such as epitaxial growth, chemical vapor deposition, atomic layer deposition, physical vapor deposition, combinations of these, or the like. In other embodiments in which the first insulator layer 103 is formed using an implantation method, the material 105 of the first active layer 201 may initially be part of the first substrate 101 prior to the implantation process to form the first insulation layer 103. However, any suitable materials and methods of manufacture may be utilized to form the material 105 of the first active layer 201.

FIG. 2 illustrates that, once the material 105 for the first active layer 201 is ready, the first optical components 203 for the first active layer 201 are manufactured using the material 105 for the first active layer 201. In embodiments the first optical components 203 of the first active layer 201 may include such components as optical waveguides (e.g., ridge waveguides, rib waveguides, buried channel waveguides, diffused waveguides, etc.), couplers (e.g., grating couplers, edge couplers that are a narrowed waveguide with a width of between about 1 nm and about 200 nm, etc.), directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 203 may be used.

To begin forming the first active layer 201 of first optical components 203 from the initial material, the material 105 for the first active layer 201 may be patterned into the desired shapes for the first active layer 201 of first optical components 203. In an embodiment the material 105 for the first active layer 201 may be patterned using, e.g., one or more photolithographic masking and etching processes. However, any suitable method of patterning the material 105 for the first active layer 201 may be utilized. For some of the first optical components 203, such as waveguides or edge couplers, the patterning process may be all or at least most of the manufacturing that is used to form these first optical components 203 components.

In one particular embodiment the first optical components 203 may comprise an edge coupler 205 located adjacent to an outside edge of the device. In an embodiment the edge coupler 205 may be a tapered edge coupler which can receive and move optical signals into an attached waveguide. In other embodiments the edge coupler 205 may comprise multi-sectional tapers, parabolic tapers, quadratic tapers, and/or exponential inverse tapers. Any suitable type of edge coupler or other coupler may be utilized.

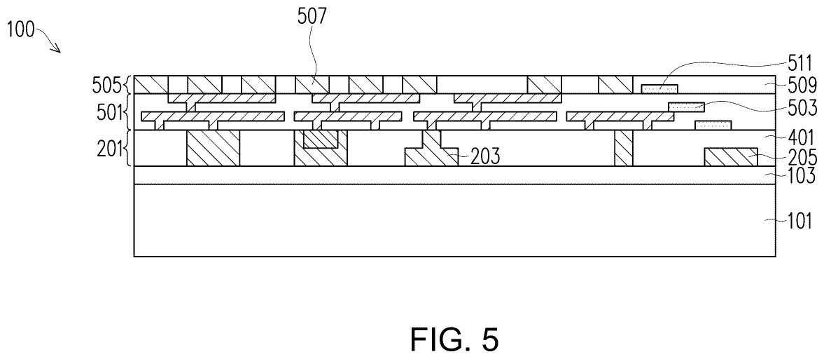

FIG. 3 illustrates that, for those components that utilize further manufacturing processes, such as Mach-Zehnder silicon-photonic switches that utilize resistive heating elements, additional processing may be performed either before or after the patterning of the material for the first active layer 201. For example, implantation processes, additional deposition and patterning processes for different materials (e.g., resistive heating elements, III-V materials for converters), combinations of all of these processes, or the like, can be utilized to help further the manufacturing of the various desired first optical components 203. In a particular embodiment, and as specifically illustrated in FIG. 3, in some embodiments an epitaxial deposition of a semiconductor material 301 such as germanium (used, e.g., for electricity/optics signal modulation and transversion) may be performed on a patterned portion of the material 105 of the first active layer 201. In such an embodiment the semiconductor material 301 may be epitaxially grown in order to help manufacture, e.g., a photodiode for an optical-to-electrical converter. All such manufacturing processes and all suitable first optical components 203 may be manufactured, and all such combinations are fully intended to be included within the scope of the embodiments.

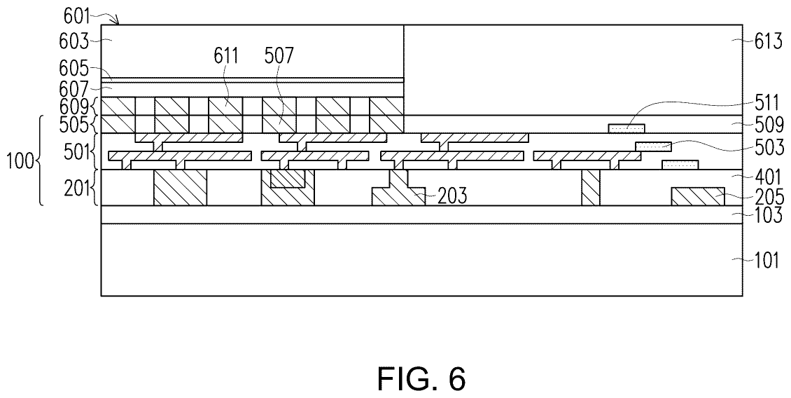

FIG. 4 illustrates that, once the individual first optical components 203 of the first active layer 201 have been formed, a second insulator layer 401 may be deposited to cover the first optical components 203 and provide additional cladding material. In an embodiment the second insulator layer 401 may be a dielectric layer that separates the individual components of the first active layer 201 from each other and from the overlying structures and can additionally serve as another portion of cladding material that surrounds the first optical components 203. In an embodiment the second insulator layer 401 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulator layer 401 has been deposited, the material may be planarized using, e.g., a chemical mechanical polishing process in order to either planarize a top surface of the second insulator layer 401 (in embodiments in which the second insulator layer 401 is intended to fully cover the first optical components 203) or else planarize the second insulator layer 401 with top surfaces of the first optical components 203. However, any suitable material and method of manufacture may be used.

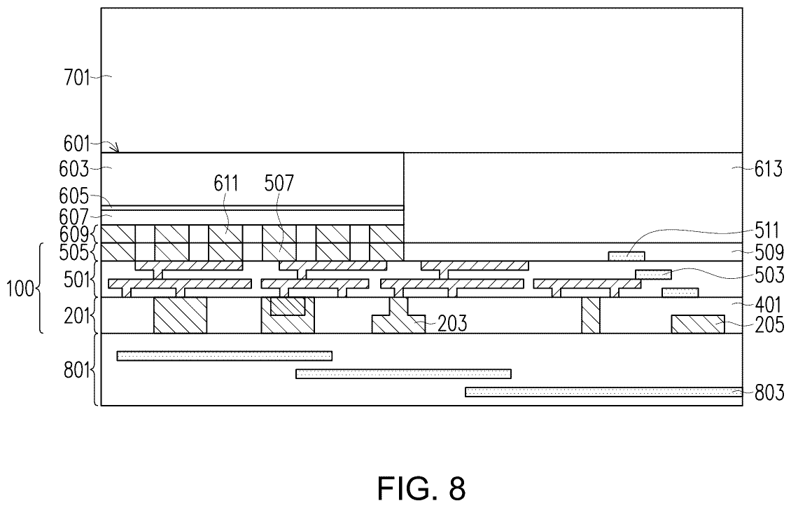

FIG. 5 illustrates that, once the first optical components 203 of the first active layer 201 have been manufactured and the second insulator layer 401 has been formed, first metallization layers 501 are formed in order to electrically connect the first active layer 201 of first optical components 203 to control circuitry, to each other, and to subsequently attached devices (not illustrated in FIG. 5 but illustrated and described further below with respect to FIG. 6). In an embodiment the first metallization layers 501 are formed of alternating layers of dielectric and conductive material and may be formed through any suitable processes (such as deposition, damascene, dual damascene, etc.). In particular embodiments there may be multiple layers of metallization used to interconnect the various first optical components 203, but the precise number of first metallization layers 501 is dependent upon the design of the optical interposer 100.

Additionally, during the manufacture of the first metallization layers 501, one or more second optical components 503 may be formed as part of the first metallization layers 501. In some embodiments the second optical components 503 of the first metallization layers 501 may include such components as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 503.

In an embodiment the one or more second optical components 503 may be formed by initially depositing a material for the one or more second optical components 503. In an embodiment the material for the one or more second optical components 503 may be a dielectric material such as silicon nitride, silicon oxide, combinations of these, or the like, or a semiconductor material such as silicon, deposited using a deposition method such as chemical vapor deposition, atomic layer deposition, physical vapor deposition, combinations of these, or the like. However, any suitable material and any suitable method of deposition may be utilized.

Once the material for the one or more second optical components 503 has been deposited or otherwise formed, the material may be patterned into the desired shapes for the one or more second optical components 503. In an embodiment the material of the one or more second optical components 503 may be patterned using, e.g., one or more photolithographic masking and etching processes. However, any suitable method of patterning the material for the one or more second optical components 503 may be utilized.

For some of the one or more second optical components 503, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 503. For example, implantation processes, additional deposition and patterning processes for different materials, combinations of all of these processes, or the like, and can be utilized to help further the manufacturing of the various desired one or more second optical components 503. All such manufacturing processes and all suitable one or more second optical components 503 may be manufactured, and all such combinations are fully intended to be included within the scope of the embodiments.

Once the one or more second optical components 503 of the first metallization layers 501 have been manufactured, a first bonding layer 505 is formed over the first metallization layers 501. In an embodiment, the first bonding layer 505 may be used for a dielectric-to-dielectric and metal-to-metal bond. In accordance with some embodiments, the first bonding layer 505 is formed of a first dielectric material 509 such as silicon oxide, silicon nitride, or the like. The first dielectric material 509 may be deposited using any suitable method, such as CVD, high-density plasma chemical vapor deposition (HDPCVD), PVD, atomic layer deposition (ALD), or the like. However, any suitable materials and deposition processes may be utilized.

Once the first dielectric material 509 has been formed, first openings in the first dielectric material 509 are formed to expose conductive portions of the underlying layers in preparation to form first bond pads 507 within the first bonding layer 505. Once the first openings have been formed within the first dielectric material 509, the first openings may be filled with a seed layer and a plate metal to form the first bond pads 507 within the first dielectric material 509. The seed layer may be blanket deposited over top surfaces of the first dielectric material 509 and the exposed conductive portions of the underlying layers and sidewalls of the openings and the second openings. The seed layer may comprise a copper layer. The seed layer may be deposited using processes such as sputtering, evaporation, or plasma-enhanced chemical vapor deposition (PECVD), or the like, depending upon the desired materials. The plate metal may be deposited over the seed layer through a plating process such as electrical or electro-less plating. The plate metal may comprise copper, a copper alloy, or the like. The plate metal may be a fill material. A barrier layer (not separately illustrated) may be blanket deposited over top surfaces of the first dielectric material 509 and sidewalls of the openings and the second openings before the seed layer. The barrier layer may comprise titanium, titanium nitride, tantalum, tantalum nitride, or the like.

Following the filling of the first openings, a planarization process, such as a CMP, is performed to remove excess portions of the seed layer and the plate metal, forming the first bond pads 507 within the first bonding layer 505. In some embodiments a bond pad via (not separately illustrated) may also be utilized to connect the first bond pads 507 with underlying conductive portions and, through the underlying conductive portions, connect the first bond pads 507 with the first metallization layers 501.

Additionally, the first bonding layer 505 may also include one or more third optical components 511 incorporated within the first bonding layer 505. In such an embodiment, prior to the deposition of the first dielectric material 509, the one or more third optical components 511 may be manufactured using similar methods and similar materials as the one or more second optical components 503 (described above), such as by being waveguides and other structures formed at least in part through a deposition and patterning process. However, any suitable structures, materials and any suitable methods of manufacture may be utilized.

FIG. 6 illustrates a bonding of a first semiconductor device 601 to the first bonding layer 505 of the optical interposer 100. In some embodiments, the first semiconductor device 601 is an electronic integrated circuit (EIC—e.g., a device without optical devices) and may have a semiconductor substrate 603, a layer of active devices 605, an overlying interconnect structure 607, a second bonding layer 609, and associated third bond pads 611. In an embodiment the semiconductor substrate 603 may be similar to the first substrate 101 (e.g., a semiconductor material such as silicon or silicon germanium), the active devices 605 may be transistors, capacitors, resistors, and the like formed over the semiconductor substrate 603, the interconnect structure 607 may be similar to the first metallization layers 501 (without optical components), the second bonding layer 609 may be similar to the first bonding layer 505, and the third bond pads 611 may be similar to the first bond pads 507. However, any suitable devices may be utilized.

In an embodiment the first semiconductor device 601 may be configured to work with the optical interposer 100 for a desired functionality. In some embodiments the first semiconductor device 601 may be a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

In an embodiment the first semiconductor device 601 and the first bonding layer 505 may be bonded using a dielectric-to-dielectric and metal-to-metal bonding process. In a particular embodiment which utilizes a dielectric-to-dielectric and metal-to-metal bonding process, the process may be initiated by activating the surfaces of the second bonding layer 609 and the surfaces of the first bonding layer 505. Activating the top surfaces of the first bonding layer 505 and the second bonding layer 609 may comprise a dry treatment, a wet treatment, a plasma treatment, exposure to an inert gas plasma, exposure to H₂, exposure to N₂, exposure to O₂, combinations thereof, or the like, as examples. In embodiments where a wet treatment is used, an RCA cleaning may be used, for example. In another embodiment, the activation process may comprise other types of treatments. The activation process assists in the bonding of the first bonding layer 505 and the second bonding layer 609.

After the activation process the optical interposer 100 and the first semiconductor device 601 may be cleaned using, e.g., a chemical rinse, and then the first semiconductor device 601 is aligned and placed into physical contact with the optical interposer 100. The optical interposer 100 and the first semiconductor device 601 are then subjected to thermal treatment and contact pressure to bond the optical interposer 100 and the laser die 600. For example, the optical interposer 100 and the first semiconductor device 601 may be subjected to a pressure of about 200 kPa or less, and a temperature between about 25° C. and about 250° C. to fuse the optical interposer 100 and the first semiconductor device 601. The optical interposer 100 and the first semiconductor device 601 may then be subjected to a temperature at or above the eutectic point for material of the first bond pads 507 and the third bond pads 611, e.g., between about 150° C. and about 650° C., to fuse the metal. In this manner, the optical interposer 100 and the first semiconductor device 601 forms a dielectric-to-dielectric and metal-to-metal bonded device. In some embodiments, the bonded dies are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

FIG. 6 additionally illustrates that, once the first semiconductor device 601 has been bonded, a first gap-fill material 613 is deposited in order to fill the space around the first semiconductor device 601 and provide additional support. In an embodiment the first gap-fill material 613 may be a material such as silicon oxide, silicon nitride, silicon oxynitride, combinations of these, or the like, deposited to fill and overfill the spaces around the first semiconductor device 601. However, any suitable material and method of deposition may be utilized.

Once the first gap-fill material 613 has been deposited, the first gap-fill material 613 may be planarized in order to expose the first semiconductor device 601. In an embodiment the planarization process may be a chemical mechanical planarization process, a grinding process, or the like. However, any suitable planarization process may be utilized.

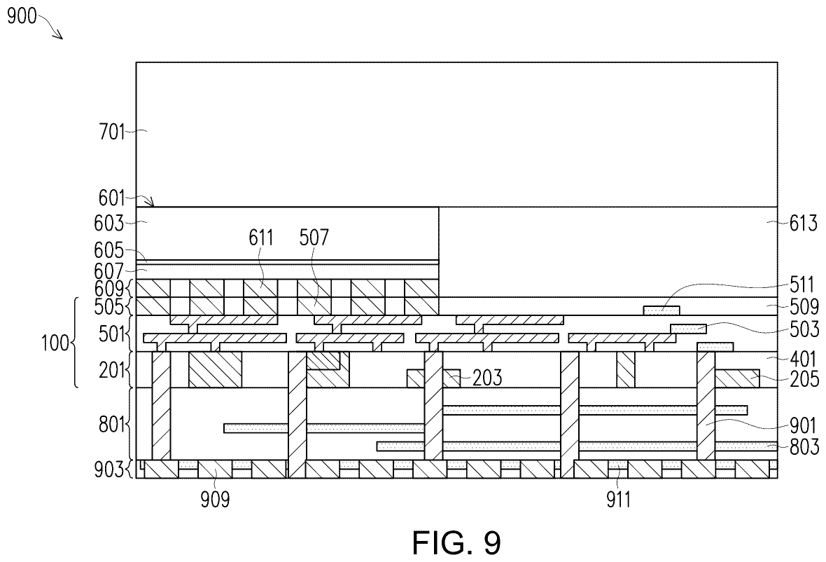

FIG. 7 illustrates an attachment of a first support substrate 701 to the first semiconductor device 601 and the first gap-fill material 613. In an embodiment the first support substrate 701 may be a support material that is transparent to the wavelength of light that is desired to be used, such as silicon, and may be attached using, e.g., an adhesive (not separately illustrated in FIG. 7). However, in other embodiments the first support substrate 701 may be bonded to the first semiconductor device 601 and the first gap-fill material 613 using, e.g., a bonding process. Any suitable method of attaching the first support substrate 701 may be used.

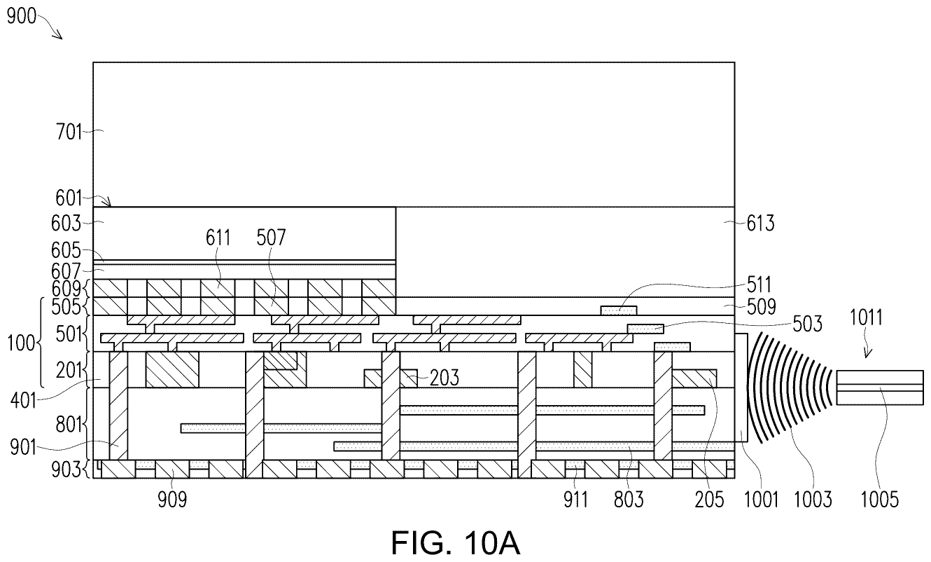

FIG. 8 illustrates a removal of the first substrate 101 and, optionally, the first insulator layer 103, thereby exposing the first active layer 201 of first optical components 203. In an embodiment the first substrate 101 and the first insulator layer 103 may be removed using a planarization process, such as a chemical mechanical polishing process, a grinding process, one or more etching processes, combinations of these, or the like. However, any suitable method may be used in order to remove the first substrate 101 and/or the first insulator layer 103.

Once the first substrate 101 and the first insulator layer 103 have been removed, a second active layer 801 of fourth optical components 803 may be formed on a back side of the first active layer 201. In an embodiment the second active layer 801 of fourth optical components 803 may be formed using similar materials and similar processes as the second optical components 503 of the first metallization layers 501 (described above with respect to FIG. 5). For example, the second active layer 801 of fourth optical components 803 may be formed of alternating layers of a cladding material such as silicon oxide and core material such as silicon nitride formed using deposition and patterning processes in order to form optical components such as waveguides and the like.

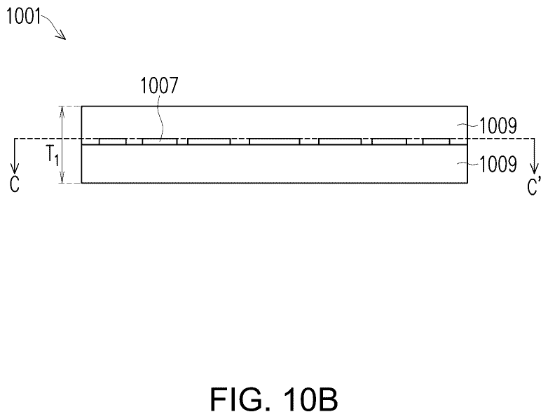

FIG. 9 illustrates formation of first through device vias (TDVs) 901, formation of a third bonding layer 903 to form a first optical package 900. In an embodiment the first through device vias 901 extend through the second active layer 801 and the first active layer 201 so as to provide a quick passage of power, data, and ground through the optical interposer 100. In an embodiment the first through device vias 901 may be formed by initially forming through device via openings into the optical interposer 100. The through device via openings may be formed by applying and developing a suitable photoresist (not shown), and removing portions of the second active layer 801 and the optical interposer 100 that are exposed.

Once the through device via openings have been formed within the optical interposer 100, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

Optionally, in some embodiments once the first through device vias 901 have been formed, second metallization layers (not separately illustrated in FIG. 9) may be formed in electrical connection with the first through device vias 901. In an embodiment the second metallization layers may be formed as described above with respect to the first metallization layers 501, such as being alternating layers of dielectric and conductive materials using damascene processes, dual damascene process, or the like. In other embodiments, the second metallization layers may be formed using a plating process to form and shape conductive material, and then cover the conductive material with a dielectric material. However, any suitable structures and methods of manufacture may be utilized.

The third bonding layer 903 is formed in order to provide electrical connections between the optical interposer 100 and subsequently attached devices. In an embodiment the third bonding layer 903 may be similar to the first bonding layer 505, such as having third bond pads 909 (similar to the first bond pads 507) and even fifth optical components 911 (similar to the third optical components 511). However, any suitable devices may be utilized.

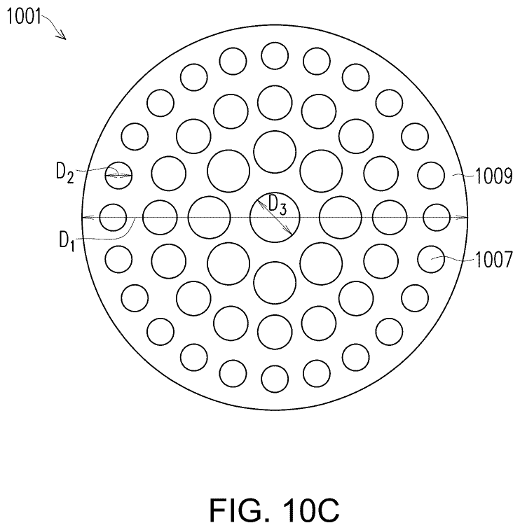

FIG. 10A illustrates a placement of a metasurface 1001 onto the first optical package 900. In an embodiment the metasurface 1001 is placed adjacent to the edge coupler 205 (e.g., attached to the second insulator layer 401) and positioned between the edge coupler 205 and an external device such as an optical fiber 1005. In such a position, the metasurface 1001 can replace any lenses and may be utilized to help optical signals 1003 transit between the optical fiber 1005 and the edge coupler 205.

Looking at FIG. 10B, the metasurface 1001 may comprise a plurality of meta-atoms 1007 embedded within one or more layers of a holding medium 1009. In an embodiment the meta-atoms 1007 are molecules or layers of a material which can be used to design arbitrary spot size and divergence angles of the light transiting through the metasurface 1001 (e.g., the optical signals 1003). As such, while the precise material for the meta-atoms 1007 is dependent at least in part on the particular wavelengths of the optical signals 1003 being used, in an embodiment in which the optical signals 1003 comprise visible light, the meta-atoms 1007 may comprise a material such as titanium oxide. However, any suitable material may be utilized.

In order to assist in the placement and attachment of the meta-atoms 1007, the meta-atoms 1007 are formed, placed, or otherwise located within the one or more layers of the holding medium 1009. In an embodiment the holding medium 1009 may be a material that holds the meta-atoms 1007 without otherwise substantively affecting the optical signals 1003 as the optical signals 1003 transit through the metasurface 1001. As such, while the precise material for the holding medium 1009 is dependent at least in part on the particular wavelengths of the optical signals 1003, in an embodiment in which the optical signals 1003 comprise visible light and the meta-atoms 1007 comprise titanium oxide, the holding medium 1009 may be a material such as silicon oxide. However, any suitable material may be utilized.

To form the metasurface 1001, an initial layer of the holding medium 1009 is utilized. Once ready, a layer of the meta-atoms 1007 may be blanket deposited over the layer of the holding medium 1009 using a deposition process such as chemical vapor deposition, physical vapor deposition, atomic layer deposition, combinations of these, or the like, to a thickness of between about 500 Å and about 10,000 Å. However, any suitable deposition method may be utilized.

Once the layer of the material for the meta-atoms 1007 has been deposited, the material for the meta-atoms 1007 is patterned into the desired shape for the meta-atoms 1007. In an embodiment the material for the meta-atoms 1007 may be patterned using, e.g., a photolithographic masking and etching process. However, any suitable patterning process may be utilized.

Optionally, once the meta-atoms 1007 have been formed on the initial layer for the holding medium 1009, the meta-atoms 1007 may be covered in order to provide additional protection and control. In an embodiment the meta-atoms 1007 may be covered by another layer of the holding medium 1009, deposited using a deposition process such as chemical vapor deposition, physical vapor deposition, atomic layer deposition, combinations of these, or the like, and then planarized in order to provide a planar surface. However, any suitable deposition method may be utilized.

In an embodiment the metasurface 1001 may have an overall thickness that is less than a lens (not illustrated because the lenses have been replaced by the metasurface 1001). In a particular embodiment the metasurface 1001 may have a first thickness T₁ of between about 10,000 Å and about 40,000 Å. However, any suitable thickness may be utilized.

FIG. 10C illustrates a top down view of the metasurface 1001 along line C-C′ of FIG. 10B. In an embodiment the metasurface 1001 may be shaped as a circle and may collectively have a first diameter D₁ that includes both the meta-atoms 1007 as well as the holding medium 1009. In a particular embodiment the first diameter D₁ may be between about 25 μm and about 250 μm. However, any suitable dimensions and any suitable shapes may be utilized.

Looking next at the top down view of the meta-atoms 1007 within the metasurface 1001, the individual meta-atoms 1007 may be arranged in any desired fashion, such as the illustrated array of meta-atoms 1007 that are arranged in a plurality of concentric circles that rotate around a central point of the metasurface 1001 (wherein the central point of the metasurface 1001 includes one of the individual meta-atoms 1007). In an embodiment, the individual meta-atoms 1007 may have a different diameter in each of the plurality of circles, such as having a second diameter D₂ of about 25 μm in an outer circle (adajcent to an edge of the metasurface 1001) and having a third diameter D₃ of about 250 μm at the central point of the metasurface 1001. Additionally, intermediate ones of the individual meta-atoms 1007 between the central point and the outer ring of circles may have intermediate diameters, such as 50 μm, 100 μm, etc.

Returning now to FIG. 10A, the metasurface 1001 may be attached to the first optical package 900 and aligned with the edge coupler 205. In an embodiment the metasurface 1001 may be attached to, e.g., the second insulator layer 401 and adjacent layers using an optical glue (not separately illustrated in FIG. 10A). In some embodiments, the optical glue comprises a polymer material such as epoxy-acrylate oligomers, and may have a refractive index between about 1 and about 3. By utilizing the optical glue, the metasurface 1001 may have a working distance of about zero, or have a working distance of at most the thickness of the optical glue. However, any suitable method of attachment may be utilized.

Once the metasurface 1001 has been attached, a fiber array unit (FAU) 1011 may be placed in order to provide an ingress and egress to the optical signals 1003. In an embodiment the fiber array unit assembly 1011 receives one or more of the optical fibers 1005, arranges the optical fibers 1005 with a fiber sheath, and directs the optical signals 1003 from the optical fibers 1005 towards the metasurface 1001.

In operation the optical signals 1003 exit the optical fibers 1005 and are directed towards the metasurface 1001. The metasurface 1001, through the design and placement of the meta-atoms 1007, works to limit the chromatic and spherical aberrations for wavelength division multiplexing as the optical signals 1003 transit through the metasurface 1001. The metasurface 1001 then directs the optical signals 1003 to the edge coupler 205 and, from the edge coupler 205, to a remainder of the first optical package 900.

By utilizing the metasurface 1001, previously used lenses (with their detrimental thicknesses and diameters as well as a large working distance), can be replaced with the metasurface 1001 that has a compact size while still achieving an achromatic effect. Additionally, the metasurface 1001 has a short working distance that can be designed to have an arbitrary spot size and divergence angle. As such, the optical device can satisfy arbitrary mode-matching requirements of edge coupling, then achieve compact size and achromatic effects simultaneously.

In an embodiment, a method of manufacturing an optical device includes: forming an optical interposer; and aligning a metasurface to an edge coupler within the optical interposer. In an embodiment the aligning the metasurface attaches the metasurface using an optical glue, the metasurface having a working distance no greater than a thickness of the optical glue. In an embodiment the metasurface comprises meta-atoms dispersed within a holding medium. In an embodiment the meta-atoms comprises titanium oxide. In an embodiment the holding medium comprises silicon oxide. In an embodiment the meta-atoms are arranged in a series of concentric circles. In an embodiment the meta-atoms in a first of the series of concentric circles have a first diameter and wherein the meta-atoms in a second of the series of concentric circles have a second diameter different from the first diameter.

In another embodiment, a method of manufacturing an optical device includes: forming first optical components on a substrate, the first optical components comprising an edge coupler; depositing a dielectric material around the first optical components; forming a bonding layer over the first optical components; attaching a semiconductor die to the bonding layer; and glueing a metasurface to the dielectric material and aligned with the edge coupler, the metasurface comprising meta-atoms dispersed over a holding medium. In an embodiment the meta-atoms comprise titanium oxide. In an embodiment the meta-atoms are arranged within the holding medium in a series of concentric circles. In an embodiment a first meta-atom within a first concentric circle has a first diameter, wherein a second meta-atom within a second concentric circle has a second diameter that is different from the first diameter. In an embodiment the first concentric circle is closer to a center of the metasurface than the second concentric circle, and wherien the first diameter is larger than the second diameter. In an embodiment the method further includes: removing the substrate; and forming second optical components on an opposite side of the first optical components from the semiconductor die. In an embodiment the holding medium comprises silicon oxide.

In yet another embodiment an optical device includes: an optical interposer; an edge coupler located within the optical interposer; and a metasurface aligned with the edge coupler. In an embodiment the metasurface comprises meta-atoms located within a holding medium. In an embodiment the meta-atoms comprise titanium dioxide. In an embodiment the holding medium comprises silicon oxide. In an embodiment the meta-atoms are arranged within the holding medium in a series of concentric circles. In an embodiment the metasurface is attached to the optical interposer with an optical glue.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of manufacturing an optical device, the method comprising:
forming an optical interposer; and
aligning a metasurface to an edge coupler within the optical interposer.

2. The method of claim 1, wherein the aligning the metasurface attaches the metasurface using an optical glue, the metasurface having a working distance no greater than a thickness of the optical glue.

3. The method of claim 1, wherein the metasurface comprises meta-atoms dispersed within a holding medium.

4. The method of claim 3, wherein the meta-atoms comprises titanium oxide.

5. The method of claim 4, wherein the holding medium comprises silicon oxide.

6. The method of claim 5, wherein the meta-atoms are arranged in a series of concentric circles.

7. The method of claim 6, wherein the meta-atoms in a first of the series of concentric circles have a first diameter and wherein the meta-atoms in a second of the series of concentric circles have a second diameter different from the first diameter.

8. A method of manufacturing an optical device, the method comprising:
forming first optical components on a substrate, the first optical components comprising an edge coupler;
depositing a dielectric material around the first optical components;
forming a bonding layer over the first optical components;
attaching a semiconductor die to the bonding layer; and
glueing a metasurface to the dielectric material and aligned with the edge coupler, the metasurface comprising meta-atoms dispersed over a holding medium.

9. The method of claim 8, wherein the meta-atoms comprise titanium oxide.

10. The method of claim 8, wherein the meta-atoms are arranged within the holding medium in a series of concentric circles.

11. The method of claim 8, wherein a first meta-atom within a first concentric circle has a first diameter, wherein a second meta-atom within a second concentric circle has a second diameter that is different from the first diameter.

12. The method of claim 11, wherein the first concentric circle is closer to a center of the metasurface than the second concentric circle, and wherien the first diameter is larger than the second diameter.

13. The method of claim 8, further comprising:
removing the substrate; and
forming second optical components on an opposite side of the first optical components from the semiconductor die.

14. The method of claim 8, wherein the holding medium comprises silicon oxide.

15. An optical device comprising:
an optical interposer;
an edge coupler located within the optical interposer; and
a metasurface aligned with the edge coupler.

16. The optical device of claim 15, wherein the metasurface comprises meta-atoms located within a holding medium.

17. The optical device of claim 16, wherein the meta-atoms comprise titanium dioxide.

18. The optical device of claim 17, wherein the holding medium comprises silicon oxide.

19. The optical device of claim 18, wherein the meta-atoms are arranged within the holding medium in a series of concentric circles.

20. The optical device of claim 15, wherein the metasurface is attached to the optical interposer with an optical glue.
